(19) United States
(12) Patent Application Publication
(10) Pub. No.: US 2021/0381649 A1
(43) Pub. Date: Dec. 9, 2021

(54) High Pressure Vessel

(71) Applicant: MAGNA Energy Storage Systems GesmbH, Sinabelkirchen (AT)

(72) Inventors: David PUNTIGAM, Gross St.Florian (AT); Andreas PREITLER, Gratkorn (AT); Rainer PUCHLEITNER, Graz (AT)

(73) Assignee: MAGNA Energy Storage Systems GesmbH, Sinabelkirchen (AT)

(21) Appl. No.: 17/234,074

(22) Filed: Apr. 19, 2021

(30) Foreign Application Priority Data
Jun. 5, 2020 (EP) 20178480.8

(51) Int. Cl. F17C 1/16

(52) U.S. Cl. CPC F17C 1/16; F17C 2201/0119; F17C 2203/0602

(57) ABSTRACT

A high-pressure container that includes a cylinder composed of a plastic, at least one half-shell composed of a plastic, a sleeve, a valve, and a seal member. The cylinder is to serve as a central member. The at least one half-shell is arranged at one axial end of the cylinder, and includes a substantially rotationally symmetrical insert as a boss member and a foot member at the end thereof facing an interior of the high-pressure container and which is embedded in the plastic of the at least one half-shell to substantially form a hollow cone or hollow cylinder. The sleeve is arranged within an inner circumference of the foot member such that the plastic of the half-shell is arranged between the sleeve and the inner circumference of the foot member. The valve is arranged in the boss member, and includes a stem portion arranged in the sleeve. The seal member includes a ring seal forming a seal between the stem portion of the valve and the sleeve.

### CROSS-REFERENCE TO RELATED APPLICATIONS

The present application claims priority 35 U.S.C. § 119 to European Patent Publication No. EP 20178480.8 (filed on Jun. 5, 2020), which is hereby incorporated by reference in its entirety.

### TECHNICAL FIELD

One or more embodiments relate to a high-pressure container, in particular, a high-pressure container for storing a fuel for a motor vehicle.

### BACKGROUND

It is known that high-pressure containers, e.g. those for storing hydrogen as fuel for motor vehicles, can be constructed from an inner layer, referred to as the “liner,” and a winding of fiber material around the liner.

The use of the technologies of blow moulding and thermoforming for the production of a container is known. Production is then based on the forming of semi-finished products in tube or sheet form. These are given their final shape via a vacuum and/or excess pressure. It is possible, for example, to produce two half-shells, which are joined together to form a container.

In the case where gas-tight liners are used for type IV containers, which are used for the pressurized storage of gases, there are two common production methods. On the one hand, the blow moulding of entire liners and, on the other hand, the method of producing segments of the container by injection moulding and extrusion, and subsequent connection of these components via a joining method.

The materials used in this process are mostly based on HDPE (high density polyethylene) or polyamides.

An important distinguishing feature for liner materials are the mechanical low-temperature properties as well as the emission properties. Monolayer materials such as polyamide have a good barrier property for gases, but do not have optimum low-temperature properties. HDPE, on the other hand, does not have a suitable barrier effect, but has very good low-temperature properties.

For this reason, it is principally polyamide that is currently being used for applications in the hydrogen sector. However, this sets limits with regard to component size, especially for blow moulding technology. Moreover, the available suitable grades are expensive and problematic when used at low temperatures because of their extensive use of additives.

High-pressure containers for gases are subject to large temperature fluctuations in the course of their operation (filling, storage and emptying). This puts high demands on the materials and, in particular, on the liner.

In connection with lightweight construction and the use of composite materials, the challenge arises in this context of connecting the different materials to one another in a gas-tight manner at the joint.

### SUMMARY

One or more embodiments are to enhance a high-pressure container in this respect and, in particular, to specify a high-pressure container which, even in a region of transition to a boss member, meets the requirements for sealing and permeation for a high-pressure container and, at the same time, can be produced in a simple and low-cost manner.

In accordance with one or more embodiments, a high-pressure container comprises a cylinder, composed of a plastic, to serve as a central member; at least one half-shell, composed of a plastic, at one axial end of the cylinder, the half-shell comprising a substantially rotationally symmetrical insert as a boss member, the insert having a foot member at the end thereof facing the container interior and which is embedded in the plastic of the half-shell to substantially form a hollow cone or hollow cylinder; a sleeve arranged within the inner circumference of the foot member such that the plastic of the half-shell is arranged between the sleeve and the inner circumference of the foot member; a valve arranged in the boss member, the valve having a stem portion arranged in the sleeve; and a seal member to form a seal between the stem portion of the valve and the sleeve.

In accordance with the one or more embodiments, a plastic, in particular, a plastic multilayer composite, is used as the material for the liner, both in the central member formed by the cylinder and in at least one, or in both axial end regions of the container. Plastics, in particular, multilayer plastics which also comprise a barrier layer, can be formed into a half-shell in a simple manner via blow moulding, or deep drawing, or vacuum moulding. It is likewise possible, for example, for the cylinder in the central member to be blow-moulded or extruded.

In accordance with the one or more embodiments, use is made of a boss member which has a foot member that substantially forms a hollow cone or hollow cylinder. The foot member of the insert is embedded in the plastic of the half-shell. The plastic thus surrounds the boss member at least on two sides. The foot member has a greater diameter than an adjacent central member of the boss member. The foot member thus forms an undercut with respect to a plastic of the liner introduced from the side of the foot member or the center of the container. The plastic is preferably arranged axially on both sides of the foot member, that is to say on both sides of the undercut, i.e., on a surface of the boss member facing the center of the container and on a surface of the boss member facing away from the center of the container.

The production of the half-shell with embedded boss member and of the entire high-pressure container is nevertheless possible in an inexpensive manner, since, as will be described in more detail later, the introduction of the plastic is possible via blow moulding or vacuum deep drawing despite undercutting on the foot member of the boss member.

The foot member is hollow in the interior, in the region of its longitudinal central axis, and therefore, substantially forms a hollow cone or a hollow cylinder.

In accordance with the one or more embodiments, a sleeve, composed of metal, is introduced into the inner circumference of the foot member. In this case, the plastic of the half-shell is arranged in some section or sections in intermediate spaces between the sleeve and the inner circumference of the foot member.

In accordance with the one or more embodiments, the high-pressure container also comprises a valve for withdrawing the medium in the high-pressure container. The valve is accommodated in the boss member in a manner such that a cylindrical stem portion of the valve is accommodated in the sleeve. One section of the stem portion of the valve is thus inserted directly in the boss member and one section in the sleeve, within the boss member.

In accordance with the one or more embodiments, a seal member, in particular, a ring seal, is arranged between the stem portion of the valve and the sleeve in such a high-pressure container in order to form a seal between the valve and the sleeve. The seal member extends around the entire stem portion of the valve, and can have a round, or a rectangular, or a conical cross section. The seal member comprises an independent, separate component. In an alternative embodiment, the seal member can also be formed integrated on the stem portion of the valve. A seal is thus used in a deep region of the valve, namely only in the stem portion of the valve and in the foot region of the boss member. The sleeve extends at least as far as the axial end of the boss member which faces the center of the container, the sleeve particularly extending beyond this end of the boss member. The seal is configured to seal the valve against the sleeve. Radially outside the sleeve, in the intermediate space towards the boss member, plastic is arranged, which can be very thin in one or more regions, and particularly, in regions in which the sleeve is press-fit into the boss member. By virtue of the arrangement of the seal member and of the sealing of said seal member with respect to the sleeve, it is possible to achieve a reliable sealing effect.

There is also preferably a sufficiently high degree of sealing in the region of the plastic radially outside the sleeve, in particular by virtue of thin formation of the plastic in one or more regions between the sleeve and the boss member. It is thus possible to dispense with an additional seal at a higher level, above the sleeve. The sleeve is preferably press-fit into the inner circumference of the foot member in a manner such that a thin plastic layer is compressed between the sleeve and the inner circumference of the foot member in the region of press fitting. The plastic of the half-shell preferably fills the entire space between the sleeve and the inner circumference of the foot member.

The plastic of the liner, i.e., the plastic of the central member and of the half-shell, preferably both half-shells, comprises a multilayer composite plastic which comprises a barrier layer.

A first groove or depression filled with the plastic of the half-shell extends around the inner circumference of the foot member, at the level of the sleeve, at least in some section or sections, that is to say, for example, in individual sectors or around the entire inner circumference of the hollow cylinder or hollow cone. The first groove or depression is filled with the plastic of the half-shell. A “depression” can be designed in a manner similar to a groove and in any case has at least one edge which acts as an undercut for the plastic lying behind it, with the result that the plastic is held positively behind the edge in the region of the inner circumference. The plastic of the half-shell is preferably pressed against the inner circumference of the foot member and into the first groove by the sleeve. The plastic thus remains reliably in the first groove and the sealing effect is further enhanced.

The foot member also has at least one second groove which is filled with the plastic of the half-shell. The second groove extends around at least in some section or sections proximate to the inner circumference of the foot member on the bottom of the foot member that faces the container interior. The second groove likewise serves primarily to increase sealing between the liner and the boss member.

The foot member additionally has at least one third groove which is filled with the plastic of the half-shell. The third groove extends around at least in some section or sections on the top surface of the foot member that faces the outside of the container. In addition to increasing sealing, the third groove also prevents detachment of the plastic from the boss member on the top surface of the foot member.

The foot member further has at least one fourth groove which is filled with the plastic of the half-shell. The fourth groove extends around at least in some section or sections proximate to the outer circumference of the foot member on the bottom of the foot member that faces the container interior. The fourth groove also prevents detachment of the plastic from the boss member.

The first groove, and/or the second groove, and/or the third groove, and/or the fourth groove can have a trapezoidal shape which grows larger towards the bottom of the groove, thus enhancing the positive engagement of the plastic in the groove. In each of the grooves, particularly the first groove and/or the second groove, an additional seal member can be arranged at the bottom of the groove.

The plastic of the cylinder preferably merges into the plastic of the half-shell. A barrier layer extends as continuously as possible in the plastic at the transition between the cylinder and the half-shell.

The plastic comprises a multilayer composite plastic. The multilayer composite plastic of the half-shell, and preferably also the multilayer composite plastic of the cylinder, comprise at least one layer of HDPE and a barrier layer comprising EVOH, a regranulate such as a regrind layer, and/or a second HDPE layer, and/or at least one adhesion-promoting layer.

The high-pressure container comprises two half-shells at the axial ends of the cylinder, both half-shells being preferably designed as described hereinabove for the first half-shell. The cylinder and the two half-shells are wrapped with a fiber material, such as a composite material comprising carbon fibers, and/or glass fibers, and/or epoxy resin.

In accordance with one or more embodiments, a method of producing a high-pressure container can preferably be conducted with a die having a first die half which forms a female die, the method comprising: placing a preheated first plastic sheet on the first die half; sucking via a vacuum or pressing via a pressure force, the first plastic sheet against the first die half in a manner such that the plastic of the first plastic sheet is arranged laterally at a distance from an insert/boss member behind an undercut of the insert/boss member, in one or more regions; and sucking or pressing via a slide, or a vacuum, or a pressure force, the plastic of the first plastic sheet from a position laterally at a distance from the insert to a position against the insert behind the undercut, thus ensuring that a space behind the undercut of the insert is filled with the plastic.

Alternatively, the first plastic sheet is sucked or pressed against the first die half in a manner such that the insert/boss member is positioned in such a way that the plastic of the first plastic sheet is arranged laterally at a distance from the insert behind an undercut of the insert in one or more regions.

In accordance with the method, the boss member is inserted into the die as an insert and enclosed with the plastic sheet such as an impermeable multilayer composite, in a blowing or deep-drawing process. The method ensures that the plastic also gets into regions behind an undercut. For this purpose, a plastic sheet is first of all sucked or pressed against the first die half via a vacuum or a pressure force. In this case, the insert can already be positioned in such a way that, as a result of the plastic being sucked or pressed against the first die half, the plastic of the first plastic sheet is arranged behind an undercut of the insert, laterally at a distance from the insert, in one or more regions.

Alternatively, it is possible for the insert to be positioned in such a way that the plastic of the first plastic sheet is arranged laterally at a distance from the insert behind the undercut only after the plastic has been sucked or pressed against the first die half, e.g., with the insert being displaced or the insert only now being introduced into the first die half.

After this, the plastic of the first plastic sheet is pressed or sucked against the insert from the side of the insert via a slide or a vacuum or a pressure force, thus ensuring that a space behind the undercut of the insert is filled with the plastic that was previously situated at the side, and positive engagement arises.

As a result, despite simple production via blow moulding or vacuum moulding, the plastic also gets into regions behind the insert, and an enhanced sealing effect of the plastic, in particular of the multilayer composite, results with respect to the insert, in particular with respect to the metallic boss member. To achieve the enclosure in the plastic, slides and/or a vacuum or compressed air are/is used.

“Laterally at a distance” in this case means essentially at a distance from a longitudinal central axis of the insert, which can also coincide with the longitudinal central axis of the pressure container. The plastic can initially be substantially parallel to the longitudinal central axis of the insert and preferably also to the surrounding container wall. The plastic is then sucked, blown, or pushed substantially normal to the longitudinal central axis of the insert, in particular, radially inwards on all sides, towards the insert.

The fact that the sucking or pressing of the plastic against the insert takes place at a later time than the positioning of the insert, with the result that the plastic is arranged laterally at a distance from the insert in one or more regions, can also be accomplished in a continuous process such that the insert is moved further and positioned in each case and that, during this process, new plastic continues to be sucked in or pressed on in each case. As a result, the positioning of the insert and the sucking in or pressing of the plastic behind the undercut takes place virtually simultaneously.

The sleeve is press-fit into the inner circumference of the foot member of the insert, wherein a thin plastic layer is preferably formed between the sleeve and the inner circumference of the foot member in the region of press fitting.

The resulting half-shell can be connected in an additional process block to a second half-shell or to an extruded or blow-moulded multilayer cylinder. This forms the core, and thus, the basis for a further winding process, in which the container can obtain its mechanical strength from a composite material of carbon and/or glass and epoxy resin.

In accordance with one or more embodiments, the die comprises a second die half which forms a punch. The second die half can be driven onto the first die half in order to form the inner contour of the half-shell. For this purpose, the second die half can form the shape of the first plastic sheet in the interior of the half-shell. It is also possible instead for a second plastic sheet, which forms the inner contour of the half-shell, to be mounted on the second die half.

After the first plastic sheet has been sucked or pressed against the first die half, the insert/boss member is raised in relation to the first die half in order to position the insert in such a way that plastic of the first plastic sheet is arranged behind the undercut, laterally at a distance from the insert. Lifting can be performed with the aid of a movable mount for the insert. In this case, the insert can be arranged on the outside of the container on the first plastic sheet and the lifting can thus take place along the longitudinal central axis of the insert and also along the longitudinal central axis of the high-pressure container, in particular, in the direction of the subsequent center of the container.

After the space behind the undercut of the insert has been filled with the plastic, the insert is lowered again in relation to the first die half. As a particular preference, the lowering takes place simultaneously with the movement of the second die half onto the first die half.

In accordance with one or more embodiments, it is only after the first plastic sheet has been sucked or pressed against the first die half that the insert is placed on the first plastic sheet in order to position the insert in such a way that plastic of the first plastic sheet is arranged behind the undercut, laterally at a distance from the insert. The insert can thus be arranged against the first plastic sheet on the inside of the container. A second plastic sheet can in turn be arranged on the inside of the container with respect to the insert.

The plastic of the first plastic sheet can be cut off axially behind the space filled with plastic, behind the undercut, ensuring that plastic is no longer present behind the undercut, in particular, on the outside of the container with respect to the undercut.

A preheated second plastic sheet is placed on the second die half, after which the second plastic sheet is sucked or pressed against the second die half via a vacuum or a pressure force, and the second die half is driven together with the second plastic sheet onto the first die half in order to form the inner contour of the half-shell.

The first plastic sheet comprises a multilayer composite that itself comprises a layer of HDPE (high density polyethylene) and a barrier layer such as EVOH (ethylene-vinyl alcohol copolymer). As a particular preference, the multilayer composite also comprises a regrind material or regranulate and/or one or more adhesion-promoting layers. HDPE forms the outermost layer of the multilayer composite and can additionally also form the innermost layer.

In accordance with one or more embodiments, a method for producing a high-pressure container comprises producing a first half-shell by a method as described hereinabove, and connecting the first half-shell to a second half-shell which can likewise comprise an insert, and which can be produced in the same manner described hereinabove; and connecting the connected first half-shell and second half-shell to at least one cylinder that is extruded or blow-moulded, and one or more end caps in order to form a closed container. The closed container may be wrapped with a fiber material such as a composite material comprising carbon fibers, and/or glass fibers, and/or epoxy resin.

### DRAWINGS

One or more embodiments will be illustrated by way of example in the drawings and explained in the description hereinbelow.

FIG. 1 through 6, illustrate sectional views of process blocks of a method for producing a half-shell for a high-pressure container, in accordance with a first embodiment.

FIG. 7 illustrates a detail depiction of FIG. 3 in the region around the undercut of the insert.

FIG. 8 illustrates a detail depiction of FIG. 4 in the region around the undercut of the insert.

FIGS. 9 through 14 illustrate sectional views of process blocks of a method for producing a half-shell for a high-pressure container, in accordance with a second embodiment.

FIG. 15 illustrates a sectional view of a high-pressure container, in accordance with one or more embodiments.

FIG. 16 illustrates a sectional view of a half-shell of a high-pressure container, in accordance with one or more embodiments.

FIG. 17 illustrates a sectional view of a half-shell of a high-pressure container with an inserted sleeve, in accordance with one or more embodiments.

FIG. 18 illustrates a sectional view of a half-shell of a high-pressure container with an inserted valve, in accordance with one or more embodiments.

FIG. 19 illustrates a sectional view of the detail A of the half-shell of FIG. 18.

FIG. 20 illustrates a sectional view of the detail A of FIG. 19 with a potential leakage path.

FIG. 21 illustrates a sectional view of a half-shell of a high-pressure container, in accordance with one or more embodiments.

FIG. 22 illustrates a sectional view of the detail B of the half-shell of FIG. 21.

### DESCRIPTION

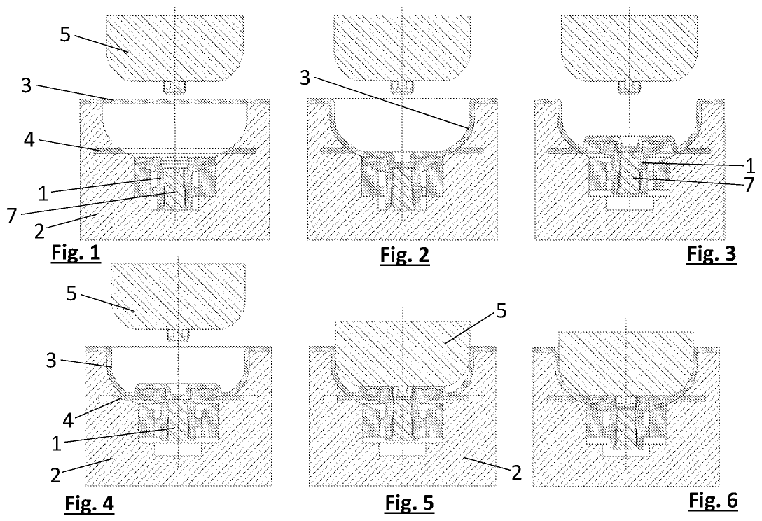

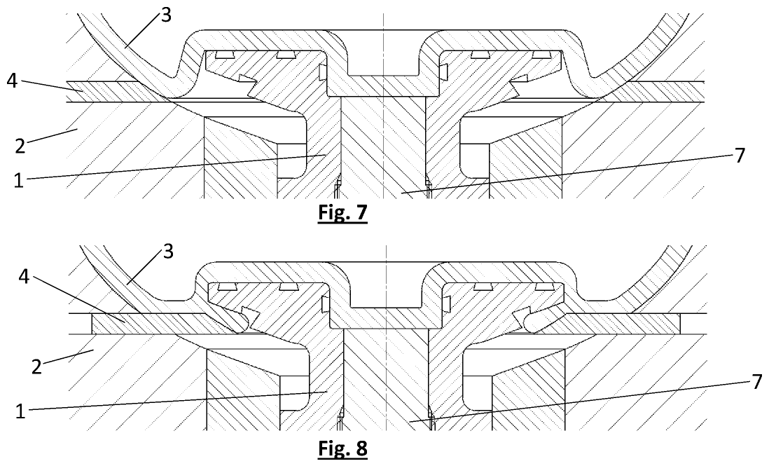

As illustrated in FIGS. 1 through 6, a method for producing a half-shell for a high-pressure container is provided in accordance with one or more embodiments. A die is used having a first die half 2 which forms a female die, and a second die half 5 which forms a punch. The die thus comprises two die halves. An insert 1 is positioned on a movable mount 7 in the first die half 2 that serves as the lower die half. The second die half 5, serving as the upper die half, acts as a punch in order to apply pressure at the end of the process. In addition, it is also possible for a second insert to be mounted on the second die half 5. With the aid of slides 4 provided in the die and/or a vacuum, the plastic is brought to the points necessary for the positive engagement. For this purpose, a preheated first plastic sheet 3 is placed on the first die half 2, and the first plastic sheet 3 is sucked or pressed against the first die half 2 via a vacuum or a pressure force. After this, the insert 1, to serve as a boss member, is positioned in such a way that plastic of the first plastic sheet 3 is arranged behind an undercut, laterally at a distance from the insert 1, in one or more regions. Alternatively, it is also possible to dispense with the movement of the insert 1, so that the plastic is immediately sucked onto a correctly positioned insert 1, as illustrated in FIG. 3.

From being laterally at a distance from the insert 1, the plastic of the first plastic sheet 3 is then pressed or sucked against the insert 1 behind the undercut via a slide 4, or a vacuum, or a pressure force, thus ensuring that a space behind the undercut of the insert 1 is filled with the plastic.

Finally, the second die half 5 is driven onto the first die half 2 in order to form the inner contour of the half-shell.

In detail, the single-sheet method illustrated in FIGS. 1 through 6 has the following process blocks.

As illustrated in FIG. 1, in a first process block of the single-sheet method, the insert 1, namely the boss member, and a preheated plastic sheet 3 are mounted on one die half, namely the first die half 2. The insert 1 is in the initial position. Optionally, it is also possible at this point for the second die half 5 to be provided with a further insert, in particular with the sleeve 20, which will be discussed later with regards to FIGS. 17 through 21).

The plastic sheet 3 is sucked with the aid of a vacuum into the first die half 2, which reproduces the outer component geometry.

As illustrated in FIGS. 3 and 4, in accordance with one or more embodiments In order to fill the space necessary for the positive engagement, behind the undercut of the insert 1 with plastic, the insert 1 is positioned on a movable mount 7 in the first die half 2. The space behind the undercut of the component is filled by lifting the component and, for example, simultaneously using a vacuum and/or slides 4.

As illustrated in FIG. 5, in the next process block, the second die half 5 is lowered with a defined closing force onto the first die half 2 and the inner contour of the component is reproduced. In the course of this process block, the insert 1 can optionally be brought back into the initial position. The plastic is thereby additionally compressed behind the undercuts and the positive engagement between the insert 1 and the plastic of the first plastic sheet 3 is increased.

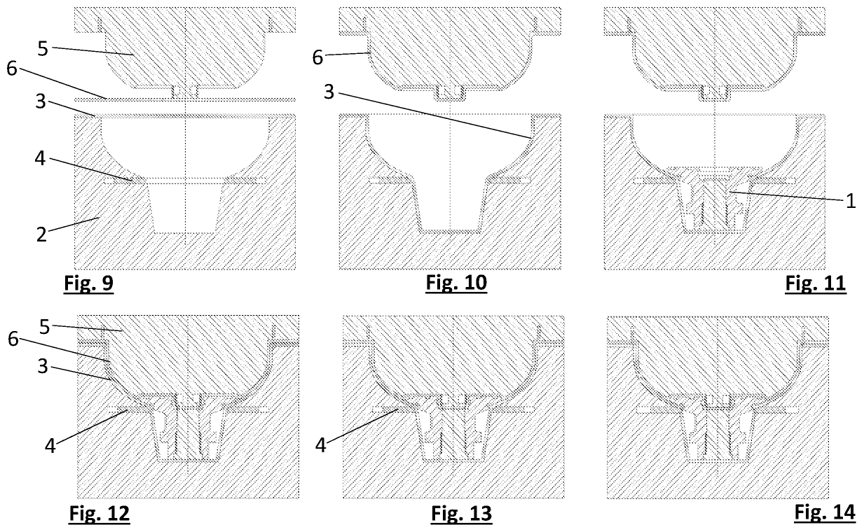

An alternative embodiment of the production method is illustrated in FIGS. 9 through 14, namely, a twin-sheet method for producing the half-shell.

As illustrated in FIG. 9, in a first process block of the twin-sheet method, a preheated plastic sheet 3, 6 is mounted on each of the die halves 2, 5. Optionally, it is possible at this point for an insert to be mounted on the second die half 5 as well.

As illustrated in FIG. 10, the plastic sheets 3, 6 are sucked with the aid of a vacuum into or against the respective die halves 2, 5, which reproduce the outer and inner component geometry, respectively.

As illustrated in FIG. 11, in the next process block, the insert 1 to be enclosed is inserted into the first die half 2.

As illustrated in FIG. 12, the space behind the undercut of the insert 1, the undercut being necessary for the positive engagement, is filled with plastic with the aid of a vacuum and/or slides 4.

As illustrated in FIG. 13, the excess material is cut off behind the undercut by cutting edges introduced into the die. These cutting edges can also be contained in the slides 4.

As illustrated in FIG. 14, the fully moulded component is provided, in which the excess plastic is cut off below the undercut and the slides 4. It is also possible for a sleeve 20 to be introduced, in particular press-fit, into the boss member and/or into the plastic within the boss member at a later point in time.

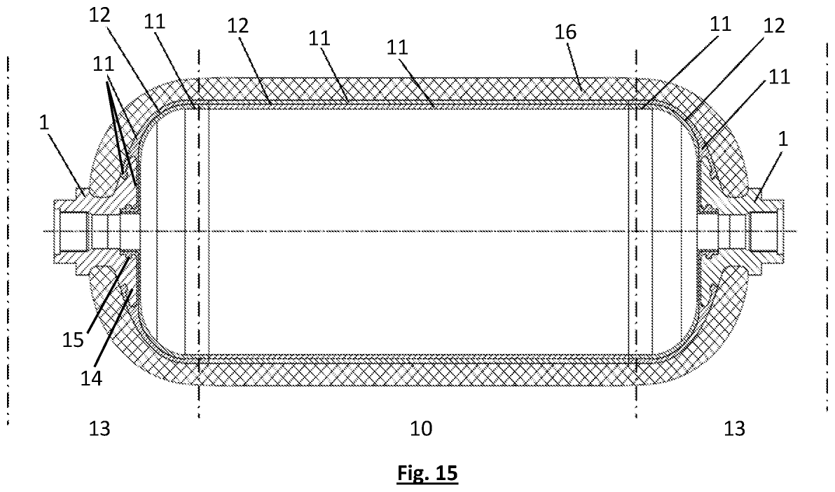

As illustrated in FIG. 15, a high-pressure container is provided in accordance with one or more embodiments. The high-pressure container comprises a cylinder 10 as a central member. The cylinder 10 is composed of a multilayer composite plastic 11 which comprises a barrier layer 12. The high-pressure container further comprises at least one half-shell 13 at one axial end of the cylinder 10, the half-shell 13 being composed of a multilayer composite plastic 11 which comprises a barrier layer 12. The half-shell 13 further comprises a substantially rotationally symmetrical insert 1 to serve as a boss member. The insert 1 comprises an undercut with respect to demoulding in the direction of the longitudinal central axis of the insert 1. The multilayer composite plastic 11 of the half-shell 13 is arranged axially on both sides of the undercut of the insert 1.

The undercut is formed by a foot member 14 at the end of the insert 1 facing the container interior, which foot member has a greater diameter than a central member of the insert 1. The multilayer composite plastic 11 is arranged axially on both sides of the foot member 14. The foot member 14 has a plurality of grooves 15 which are filled with the multilayer composite plastic 11 of the half-shell 13. The insert 1 substantially has the shape of a hollow cylinder. The foot member 14 substantially has the shape of a hollow cone. The grooves 15 filled with the multilayer composite plastic 11 of the half-shell 13 extends around an inner circumference of the foot member 14.

The multilayer composite plastic 11 of the cylinder 10 merges into the multilayer composite plastic 11 of the half-shell 13. The multilayer composite plastic 11 of the half-shell 13 and also that of the cylinder 10 comprises a layer of HDPE as the outermost layer and a barrier layer 12 of EVOH. The HDPE can be in the form of HDPE-S (black), which can be followed by a regranulate layer, an adhesion promoter, the EVOH layer, optionally again by an adhesion promoter and optionally also, once again, by an HDPE layer as the innermost layer.

The high-pressure container comprises two half-shells 13 at the axial ends of the cylinder 10, both half-shells 13 being designed as described hereinabove, i.e., having an insert as a boss member 1 which is embedded in the multilayer composite plastic 11. The cylinder 10 and the two half-shells 13 are preferably wrapped with a fiber material 16, preferably with a composite material comprising carbon fibers and/or glass fibers and/or epoxy resin.

Overall, a high-pressure container is thus specified which can be used for the storage of gases under high pressure. This is of lightweight construction and has a multi-part multilayer plastic liner, comprising two dome caps 13 and a cylinder 10, which ensures gas tightness and contains a permeation barrier 12. Inserts 1, namely boss members, more precisely a “headstock” and a “tailstock” are integrated into both dome caps 13. Both in the dome caps 13 and in the cylinder tube 10, the permeation properties are provided by a sealing layer or barrier layer 12 contained in the layered structure of the liner. The high-pressure container acquires its mechanical strength from a fiber-reinforced composite 16, which is applied to the plastic liner in a winding process and subsequently cured.

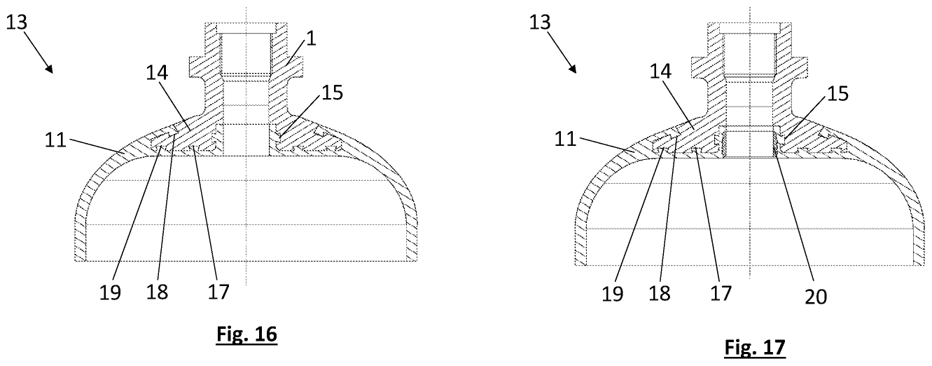

As illustrated in FIG. 16, a half-shell 13 of a high-pressure container before the sleeve 20 is inserted is provided in accordance with one or more embodiments. The half-shell 13 is composed of a multilayer composite plastic 11, which comprises a barrier layer 12. The half-shell 13 further comprises a substantially rotationally symmetrical insert 1 as a boss member. The insert 1 has a foot member 14 at the end of the insert 1 facing the container interior, which foot member 14 has a greater diameter than a central member of the insert 1. The foot member 14 substantially forms a hollow cone.

A first groove 15 filled with the multilayer composite plastic 11 of the half-shell 13 extends around the inner circumference of the foot member 14. The multilayer composite plastic 11 of the half-shell 13 is arranged axially on both sides of the foot member 14.

The foot member 14 has a second groove 17 which is filled with the multilayer composite plastic 11 of the half-shell 13, the second groove 17 extending around proximate to the inner circumference of the foot member 14 on the bottom of the foot member 14, the bottom facing the container interior.

The foot member 14 also has a third groove 18 which is filled with the multilayer composite plastic 11 of the half-shell 13, the third groove 18 extending around on the top surface of the foot member 14, the top surface facing the outside of the container.

The foot member 14 additionally has a fourth groove 19 which is filled with the multilayer composite plastic 11 of the half-shell 13, the fourth groove 19 extending around proximate to the outer circumference of the foot member 14 on the bottom of the foot member 14, the bottom facing the interior of the container.

As illustrated in FIG. 17, after completion of the half-shell, a sleeve 20 is arranged radially to the inside of the first groove 15 within the inner circumference of the foot member 14. The multilayer composite plastic 11 of the half-shell 13 is pressed against the inner circumference of the foot member 14 and into the first groove 15 by the sleeve 20.

As illustrated in FIG. 18, a complete half-shell with an inserted, tightly seated valve 21 is provided in accordance with one or more embodiments. A sleeve 20 is arranged within the inner circumference of the foot member 14. The plastic 11 of the half-shell 13 is arranged between the sleeve 20 and the inner circumference of the foot member 14. The high-pressure container comprises a valve 21 which is accommodated in the insert 1 (i.e., boss member), a stem portion of the valve 21 being accommodated in the sleeve 20. A ring seal as a seal member 22 seals between the stem portion of the valve 21 and the sleeve 20.

As illustrated in FIG. 19, the detail A of FIG. 18 is depicted more precisely. The sleeve 20 is press-fit into the inner circumference of the foot member 14 in a manner such that a thin plastic layer of the plastic 11 remains between the sleeve 20 and the inner circumference of the foot member 14 in the region of press fitting. The plastic 11 of the half-shell 13 fills the entire space between the sleeve 20 and the inner circumference of the foot member 14.

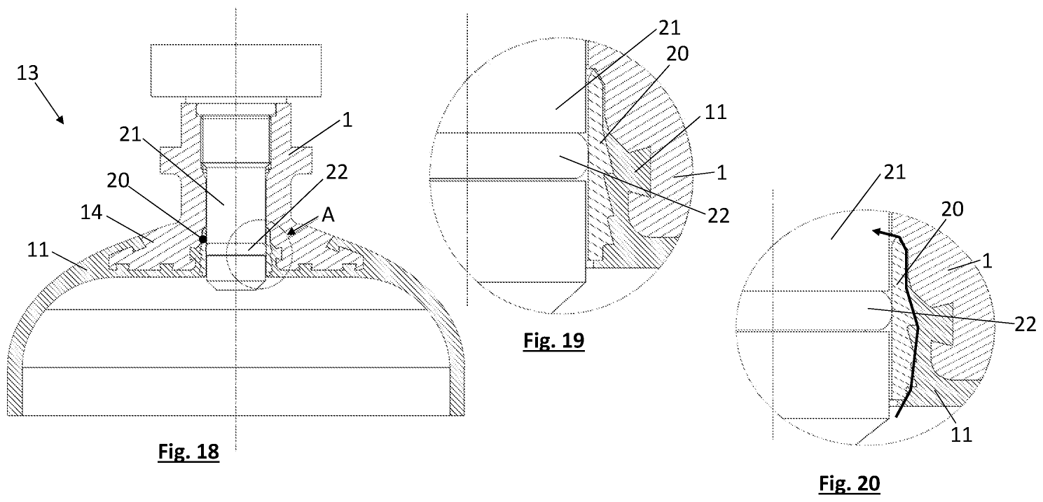

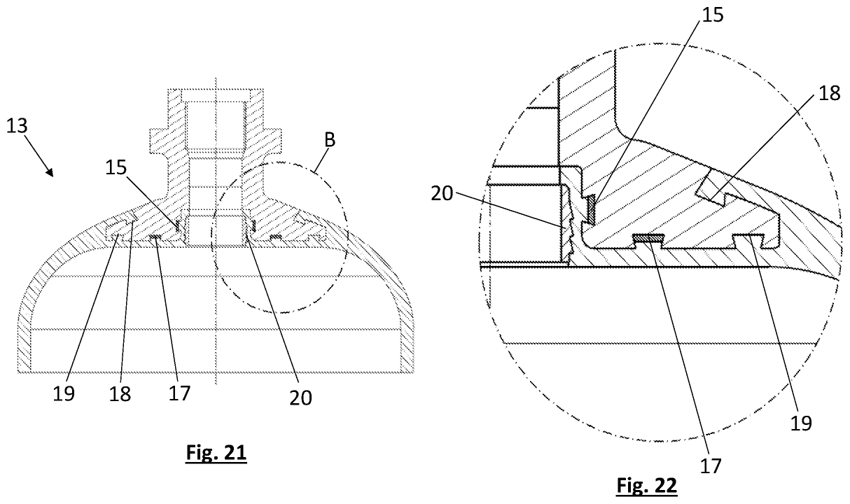

As illustrated in FIG. 20, by virtue of the action of the seal member 22 between the valve 21 and the sleeve 20, all that is necessary is to ensure sealing in the region of the plastic 11 outside the sleeve 20. By virtue of the thin plastic layer between the sleeve 20 and the inner circumference of the insert 1, there is a high level of sealing in the region of the leakage path (shown as an arrow in FIG. 20) after the sleeve 20 has been press-fit. By virtue of the small thickness of the plastic film, thermal expansion during operation as well as shrinkage during the production process are negligible in this region and good sealing is ensured.

As illustrated in FIG. 21 and the detail segment thereof in detail B in FIG. 22, a seal member can be arranged at the bottom of the grooves, in particular, of the first groove 15 and of the second groove 17. The primary sealing effect is achieved by the compression of the plastic in the circumferential grooves 15 and 17 on the metal lower part or in the core hole bore of the foot member of the boss member 1. Two further grooves 18, 19 on the outside of the disc or upper surface of the disc serve primarily for positive engagement and stabilization of the plastic-metal joint. By virtue of the sleeve 20 being pushed into the core hole bore in the course of the manufacturing process, the pressure on the sealing plastic material in the first groove 15 is increased. In one or more embodiments, one or both sealing grooves 15, 17 (as illustrated in FIG. 19) are provided with an additional seal member to increase the sealing effect in this region.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 insert, boss member

2 first die half

3 first plastic sheet

4 slide

5 second die half

6 second plastic sheet

7 mount

10 cylinder

11 multilayer composite plastic

12 barrier layer

13 half-shell

14 foot member

15 first groove

16 fiber material

17 second groove

18 third groove

19 fourth groove

20 sleeve

21 valve

22 seal member

What is claimed is:

1. A high-pressure container, comprising:
a high-pressure container comprises a cylinder, composed of a plastic, to serve as a central member;
at least one half-shell, composed of a plastic, at one axial end of the cylinder, the half-shell including a substantially rotationally symmetrical insert as a boss member, and a foot member at the end thereof facing an interior of the high-pressure container and which is embedded in the plastic of the at least one half-shell to substantially form a hollow cone or hollow cylinder;
a sleeve arranged within an inner circumference of the foot member such that the plastic of the half-shell is arranged between the sleeve and the inner circumference of the foot member;
a valve arranged in the boss member, the valve having a stem portion arranged in the sleeve; and
a seal member including a ring seal to form a seal between the stem portion of the valve and the sleeve.

2. The high-pressure container of claim 1, wherein the sleeve is press-fit into the inner circumference of the foot member in a manner such that a thin plastic layer is compressed between the sleeve and the inner circumference of the foot member in a region of the press-fitting.

3. The high-pressure container of claim 1, wherein the plastic of the half-shell fills the entire space between the sleeve and the inner circumference of the foot member.

4. The high-pressure container of claim 1, wherein the plastic comprises a multilayer composite plastic to serve as a barrier layer.

5. The high-pressure container of claim 4, further comprising a first groove, filled with the multilayer composite plastic of the half-shell, extending around the inner circumference of the foot member at a level of the sleeve, at least in one or more sections.

6. The high-pressure container of claim 4, wherein the multilayer composite plastic of the half-shell is arranged axially on both sides of the foot member.

7. The high-pressure container of claim 4, wherein:
the foot member has at least one second groove which is filled with the multilayer composite plastic of the half-shell, and
the second groove extends around at least in one or more sections proximate to the inner circumference of the foot member on a bottom of the foot member, the bottom facing the container interior.

8. The high-pressure container of claim 4, wherein:
the foot member has at least one third groove which is filled with the multilayer composite plastic of the half-shell, and
the third groove extends around at least in one or more sections on a top surface of the foot member, the top surface facing the outside of the container.

9. The high-pressure container of claim 4, wherein:
the foot member has at least one fourth groove which is filled with the multilayer composite plastic of the half-shell, and
the fourth groove extends around at least in one or more sections proximate to an outer circumference of the foot member on the bottom of the foot member, the bottom facing the container interior.

10. The high-pressure container of claim 1, further comprising a fiber material to encapsulate the cylinder and the at least one half-shells, the fiber material comprising a composite material having carbon fibers, and/or glass fibers, and/or epoxy resin.

11. A high-pressure container, comprising:
a high-pressure container comprises a cylinder, composed of a plastic, to serve as a central member;
a first half-shell, composed of a plastic, at a first axial end of the cylinder, the first half-shell including a substantially rotationally symmetrical first insert as a first boss member, and a first foot member at the end thereof facing an interior of the high-pressure container and which is embedded in the plastic of the first half-shell to substantially form a hollow cone or hollow cylinder;
a second half-shell, composed of a plastic, at a second axial end of the cylinder, the second half-shell including a substantially rotationally symmetrical second insert as a second boss member, and a second foot member at the end thereof facing an interior of the high-pressure container and which is embedded in the plastic of the second half-shell to substantially form a hollow cone or hollow cylinder;
a first sleeve arranged within an inner circumference of the first foot member such that the plastic of the first half-shell is arranged between the first sleeve and the inner circumference of the first foot member;
a second sleeve arranged within an inner circumference of the second foot member such that the plastic of the second half-shell is arranged between the second sleeve and the inner circumference of the second foot member;
a first valve arranged in the first boss member, the first valve having a first stem portion arranged in the first sleeve;
a second valve arranged in the second boss member, the second valve having a second stem portion arranged in the second sleeve;
a first seal member including a first ring seal to form a first seal between the first stem portion of the first valve and the first sleeve; and
a second seal member including a second ring seal to form a second seal between the second stem portion of the second valve and the second sleeve.

12. The high-pressure container of claim 11, wherein:
the first sleeve is press-fit into the inner circumference of the first foot member in a manner such that a thin first plastic layer is compressed between the first sleeve and the inner circumference of the first foot member in a region of the press-fitting, and
the second sleeve is press-fit into the inner circumference of the second foot member in a manner such that a thin second plastic layer is compressed between the second sleeve and the inner circumference of the second foot member in a region of the press-fitting.

13. The high-pressure container of claim 11, wherein:
the plastic of the first half-shell fills the entire space between the first sleeve and the inner circumference of the first foot member; and
the plastic of the second half-shell fills the entire space between the second sleeve and the inner circumference of the second foot member.

14. The high-pressure container of claim 11, wherein:
the plastic of the first half-shell comprises a multilayer composite plastic to serve as a first barrier layer, and
the plastic of the second half-shell comprises a multilayer composite plastic to serve as a second barrier layer.

15. The high-pressure container of claim 14, further comprising:
a first groove, filled with the multilayer composite plastic of the first half-shell, extending around the inner circumference of the first foot member at a level of the first sleeve, at least in one or more sections, and
a second groove, filled with the multilayer composite plastic of the second half-shell, extending around the inner circumference of the second foot member at a level of the second sleeve, at least in one or more sections.

16. The high-pressure container of claim 14, wherein:
the multilayer composite plastic of the first half-shell is arranged axially on both sides of the first foot member,
the multilayer composite plastic of the second half-shell is arranged axially on both sides of the second foot member.

17. The high-pressure container of claim 14, wherein:
the first foot member has at least one third groove which is filled with the multilayer composite plastic of the first half-shell, the third groove extending around at least in one or more sections proximate to the inner circumference of the first foot member on a bottom of the first foot member, the bottom facing the container interior; and
the second foot member has at least one fourth groove which is filled with the multilayer composite plastic of the second half-shell, the fourth groove extending around at least in one or more sections proximate to the inner circumference of the second foot member on a bottom of the second foot member, the bottom facing the container interior.

18. The high-pressure container of claim 14, wherein:
the first foot member has at least one fifth groove which is filled with the multilayer composite plastic of the first half-shell, the fifth groove extending around at least in one or more sections on a top surface of the first foot member, the top surface facing the outside of the container, and
the second foot member has at least one sixth groove which is filled with the multilayer composite plastic of the second half-shell, the sixth groove extending around at least in one or more sections on a top surface of the second foot member, the top surface facing the outside of the container.

19. The high-pressure container of claim 14, wherein:
the first foot member has at least one seventh groove which is filled with the multilayer composite plastic of the first half-shell, the seventh groove extending around at least in one or more sections proximate to an outer circumference of the first foot member on the bottom of the first foot member, the bottom facing the container interior, and
the second foot member has at least one eighth groove which is filled with the multilayer composite plastic of the second half-shell, the eighth groove extending around at least in one or more sections proximate to an outer circumference of the second foot member on the bottom of the second foot member, the bottom facing the container interior.

20. The high-pressure container of claim 21, further comprising a fiber material to encapsulate the cylinder, the first half-shell, and the second half-shell, the fiber material comprising a composite material having carbon fibers, and/or glass fibers, and/or epoxy resin.
